(19) United States
(12) Patent Application Publication
(10) Pub. No.: US 2007/0204046 A1
(43) Pub. Date: Aug. 30, 2007

(54) Methods and apparatus for balanced load distribution in wireless switch architecture

(76) Inventors: Puneet Batta, Santa Clara, CA (US); Anup Deshmukh, San Jose, CA (US)

Correspondence Address: INGRASSIA FISHER & LORENZ, P.C., 7150 E. CAMELBACK, STE. 325, SCOTTSDALE, AZ, 85251, US

(21) Appl. No.: 11/364,814

(22) Filed: Feb. 28, 2006

(51) Int. Cl. G06F 15/173

(52) U.S. Cl. 709/226

(57) ABSTRACT

Load-balancing is achieved in a wireless switching system or other client/server system operating over a digital network by transmitting current server loads to the clients, which then include the transmitted server load value in an ensuing reply. If the system load changes significantly between the original transmission of the server load and the receipt of the ensuing message from the client, connections to the client can be rejected, redirected to another server or otherwise processed as appropriate. Although the load balancing techniques can be implemented in any type of client/server environment, they are well-suited to wireless switch architectures that include wireless access points providing an interface between user modules and the wireless switch.

### TECHNICAL FIELD

The present invention relates generally to wireless local area networks (WLANs) and, more particularly, to load balancing of wireless access ports in a WLAN.

### BACKGROUND

In recent years, there has been a dramatic increase in demand for mobile connectivity solutions utilizing various wireless components and wireless local area networks (WLANs). This generally involves the use of wireless access points that communicate with mobile devices using one or more RF channels.

In one class of wireless networking systems, relatively unintelligent access ports act as RF conduits for information that is passed to the network through a centralized intelligent switch, or “wireless switch,” that controls wireless network functions. In such systems, however, effective client/server load balancing between various nodes (e.g. between wireless switches and access points and/or between access points and mobile units) can be challenging.

In conventional load balancing, a server advertises a current load to potential clients. The clients then observe current loads for multiple servers, and then establish connections with the server having the lowest advertised load. While this scheme is adequate for many purposes, it can exhibit a marked disadvantage when server loads change rapidly. That is, if multiple client nodes respond to the same load advertisement, then the load on the server providing the advertisement can increase very rapidly. As an example, if a first server on a network broadcasts a load of “2” and a second server broadcasts a load of “4” when ten new client nodes come online (e.g. following a power failure), each of the ten nodes will identify the first server as the least loaded, and will then attempt to connect to that server. In this exemplary situation, the result could be that the first server supports twelve connections and the second supports only the original four, when a balanced load distribution of eight nodes on each server would have been more preferable. Other load balancing techniques can result in similarly unbalanced loads in certain situations.

Accordingly, it is desirable to provide a load balancing scheme that can adequately respond to challenging network conditions. Other desirable features and characteristics will become apparent from the subsequent detailed description and the appended claims, taken in conjunction with the accompanying drawings and the foregoing technical field and background.

### BRIEF SUMMARY

Load-balancing is achieved in a wireless switching system or other client/server environment operating over a digital network by transmitting current server loads to the clients, which then include the transmitted server load value in an ensuing reply. If the system load changes significantly between the original transmission of the server load and the receipt of the ensuing message from the client, connections to the client can be rejected, redirected to another server or otherwise processed as appropriate. Although the load balancing techniques can be implemented in any type of client/server environment, they are well-suited to wireless switch architectures that include wireless access points providing an interface between mobile units and the wireless switch. Load balancing may be applied, for example, between mobile units and access points, and/or between access points and wireless switches.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual overview of an exemplary wireless network; and

FIG. 2 is a conceptual diagram of an exemplary process for establishing a connection between a client and a server that maintains load balancing between multiple servers.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description.

According to various exemplary embodiments, improved load balancing is provided by configuring adoption messages sent from the client to the server to include load information previously transmitted by the server. When the server receives such an adoption message, it is able to verify that loading information has not changed since the transmission, therefore ensuring that both client and server nodes agree on the current loading information. If the client and server do not agree on current loading, the connection between the two nodes may be rejected, redirected or restructured as appropriate, thereby improving loading across servers operating within the system.

Various aspects of the exemplary embodiments may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements and/or the like, which may carry out a variety of functions under the control of one or more microprocessors or other control devices. In addition, the present invention may be practiced in conjunction with any number of data transmission protocols and that the system described herein is merely one exemplary application for the invention.

For the sake of brevity, conventional techniques related to signal processing, data transmission, signaling, network control, the IEEE 802.11 family of specifications, and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

Without loss of generality, in the illustrated embodiment, many of the functions usually provided by a traditional wireless access point (e.g., network management, wireless configuration, and the like) can be concentrated in a corresponding wireless switch. It will be appreciated that the present invention is not so limited, and that the methods and systems described herein may be used in the context of other network environments, including any architecture that makes use of client-server principles or structures.

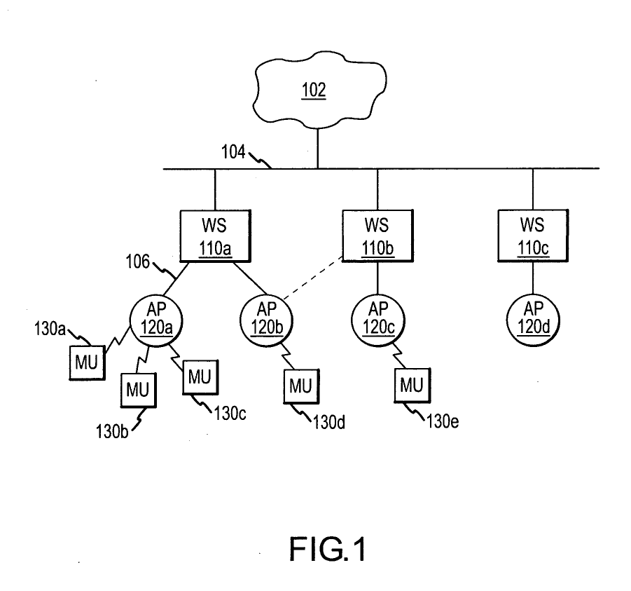

Referring now to FIG. 1, one or more switching devices 110 (alternatively referred to as “wireless switches,” “WS,” or simply “switches”) are coupled via one or more networks 104 (e.g., an ETHERNET or other local area network coupled to one or more other networks or devices, indicated by network cloud 102). One or more wireless access ports 120 (alternatively referred to as “access ports” or “APs”) are configured to wirelessly connect switches 110 to one or more mobile units 130 (or “MUs”) after a suitable AP adoption process. APs 120 are suitably connected to corresponding switches 110 via communication lines 106 (e.g., conventional Ethernet lines). Any number of additional and/or intervening switches, routers, servers and other networks or components may also be present in the system. Similarly, APs 120 may have a single or multiple built-in radio components.

A particular AP 120 may have a number of associated MUs 130. For example, in the illustrated topology, MUs 130(a), 130(b) and 130(c) are logically associated with AP 120(a), while MU 130(d) is associated with AP 120(b) and MU 130(e) is associated with AP 120(c). Furthermore, one or more APs 120 may be logically connected to a single switch 110. Thus, as illustrated, AP 120(a) and AP 120(b) are connected to WS 110(a), and AP 120(c) is connected to WS 110(b).

As noted above, each AP 120 establishes a logical connection to at least one WS 110 through a suitable adoption process. In a typical adoption process, each AP 120 responds to a “parent” message transmitted by one or more WSs 110. The parent messages may be transmitted in response to a request message broadcast by the AP 120 in some embodiments; alternatively, one or more WSs 110 may be configured to transmit parent broadcasts on any periodic or a periodic basis. The parent message typically contains an indication of the server load at the time the message is transmitted so the receiving AP 120 can compare loads of various WSs 110, and select the WS 110 with the lowest load. In the embodiment illustrated in FIG. 1, for example, AP 120b may receive parent messages from both WS 110a and 110b, and may select an appropriate WS 110 server based upon the current loads transmitted from each server.

When the AP 120 has decided upon a suitable “parent” WS 110, AP 120 transmits an “adopt” message to the appropriate parent WS 110. To avoid problems resulting from rapid changes in server loads, the “adopt” message suitably includes the indication of server load previously transmitted by the WS 110 in the “parent” message. By including this information in the adoption message, WS 110 can verify that the load has not changed (or has not changed substantially) since the parent message was sent, and can therefore ensure that the client's selection of the WS 110 as a parent was based upon current and correct information. If the loading information has not changed substantially, then the connection between the WS 110 and the AP 120 can proceed normally.

Following the adoption process, each WS 110 determines the destination of packets it receives over network 104 and routes that packet to the appropriate AP 120 if the destination is an MU 130 with which the AP is associated. Each WS 110 therefore maintains a routing list of MUs 130 and their associated APs 130. These lists are generated using a suitable packet handling process as is known in the art. Thus, each AP 120 acts primarily as a conduit, sending/receiving RF transmissions via MUs 130, and sending/receiving packets via a network protocol with WS 110. Equivalent embodiments may provide additional or different functions as appropriate.

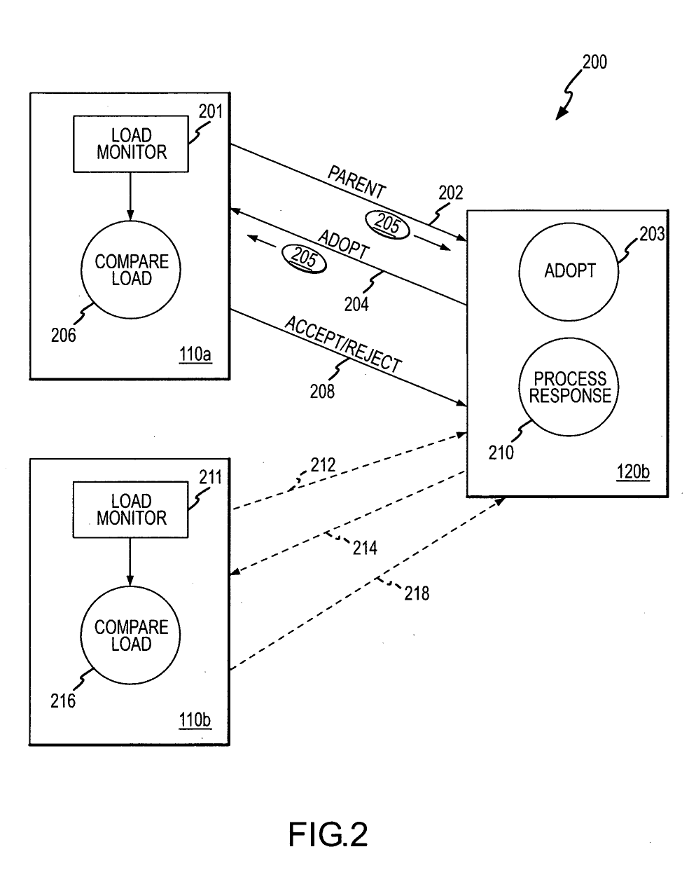

FIG. 2 illustrates an exemplary process 200 for establishing a connection between a client and one or more server nodes. While the illustrated example relates to an AP 120(b) establishing a load balanced connection with WS 110(a) or WS 110(b), alternate embodiments could apply equivalent concepts to any type of client or server nodes. Load balancing techniques could be applied between any number of APs 120 to assign connections with MUs 130, for example.

With reference to FIG. 2, the exemplary process for establishing a connection between client 120(b) and one or more servers 110(a), 110(b) suitably includes the broad steps of transmitting a parent message 202 from a server 110 that includes an indication 205 of the load on server 110; formulating an “adopt” message 204 or 214 that includes the transmitted load indication 205 in response to one or more parent messages 202, 212; comparing the load indication 205 in the received adopt message with a then-current server load; and providing an appropriate response 208, 218 from the server to the client that accepts or rejects the client/server connection. While the particular process 200 shown in FIG. 2 includes communications between a single client 102(b) and two servers 110(a) and 110(b), alternate but equivalent embodiments may apply any subset of messages and processing steps involving any number of client and/or server nodes. Further, the various communications and processes shown in FIG. 2 are intended as representations of general concepts that may be readily implemented by a skilled artisan in any number of ways; they are not intended to necessarily set forth a particular software implementation, for example. As such, the concepts and techniques described herein may be implemented using any sort of hardware, software, firmware and/or other processing logic, and may be stored and executed on any number of processors and/or digital storage media (e.g. random access or read only memory, flash memory, integrated circuitry, magnetic or optical media, and/or the like).

As noted above, loads are balanced between multiple server nodes 110(a)-(b) by facilitating re-transmission of received server load data 205 from the client 120. Because previously-sent load data 205 can be compared against then-current load information, both client and server nodes can be verified to have similar or identical load expectations before the connection is established. In the event of rapidly-changing server loads, then, the server can reject, redirect or otherwise process adoption requests in a manner that accounts for changes in server load since the initial parent message was sent.

Each server 110(a), 110(b) includes a suitable load monitor module 201, 211 (respectively) that maintains a count or other indication of the current loading of the server node. “Loading” may refer to a number of current client/server connections, or to any other metric of node performance such as processor or memory utilization, storage space available, and/or any other indication. In general, it is desirable to balance the utilization of the resource tracked by load monitors 201, 211 across multiple server nodes 110(a), 110(b) though assignment of connections with clients 120. In the example of FIG. 2, for example, load monitors 201, 211 represent any accumulator, register, memory location or other logical construct capable of maintaining an accurate accounting of the number of client connections currently handled by the server nodes 110(a) and 110(b), respectively.

Prior to establishing a connection with a server 110, client node 120(b) suitably receives one or more parent messages 202, 212 from any number of server nodes 110(a)-(b). Parent messages 202, 212 may be sent in response to a broadcast request for such information from client node 120(b). Alternatively, parent messages 202, 212 may be transmitted automatically by server nodes 110(a)-(b) on any suitable periodic, a periodic or other basis. Parent messages 202, 212 suitably include load information 205 obtained from servers 110(a), 110(b). Such information may be represented within any data field of the parent message 202, 212 as appropriate. The current load 205 may be represented with any number of binary bits, for example, which may be located at any point within message 202, 212.

After receiving one or more parent messages 202, 212 with load information 205, client 120(b) chooses a server node according to any appropriate adoption process 203. In various embodiments, client 120 receives parent messages 202, 212 from multiple servers 110 and then chooses to “adopt” the server 110 with the lowest load indication 205. Alternatively, a “default” server may be assigned, with reversion to a secondary server in the event that loading on the primary server becomes excessive. In still other embodiments, client 120 selects an initial server 110 according to any technique, and the initial server 110 provides an identity of a fallback server 110 in the event that server loading becomes excessive. In the exemplary embodiment, server 110(a) is assumed to be the “parent” node selected by client node 120(b), although this distinction is purely arbitrary. In the process of establishing a connection to server 110(a), however, various communications with server 110(b) may occur, as indicated by dashed lines in FIG. 2 representing a parent message 212, an adopt message 214 and an accept reject message 218. As noted above, the particular adoption routine applied can vary significantly from embodiment to embodiment.

After a server node is selected, client 120 replies to that server 110 with an “adopt” message 204. Adopt message 204 is formatted in any manner to include the indication 205 of the server load that was transmitted by server 10(a) in parent message 202, as appropriate. When the adopt message 204 is received by server 110(a), the server 110(a) can compare the originally-sent server load 205 with the then-current load obtained from load monitor 201 to verify that the server load 201 has not changed substantially since parent message 202 was sent. “Substantially” in this sense is intended to reflect that minor differences between the earlier-transmitted load 205 and the current load 201 may be tolerable in some implementations where precise load balancing is not necessary. The comparison of the load information 205 received via adopt message 204 with the current value of load monitor 201 is represented in FIG. 2 with logic 206 of servers 110(a). If the connection is accepted, server 102 notifies the client 120 with an appropriate accept message 208. Similarly, if client 120 were to select server 110(b) as its parent, load data contained within adopt message 214 would be compared with a then-current value of load monitor 211 by logic 216, and an ensuing accept or reject message 218 would be sent.

Again assuming that server 110(a) is selected as the “parent” server for client 120(b), appropriate action can be taken if substantial differences do exist between the server load 205 indicated in adopt message 204 and the current server load indicated by load monitor 201. In various embodiments, server 110(a) simply notifies client 120(b) (via message 208) that the connection is rejected. In this scenario, client 120(b) would then contact a manually-configured fallback server, or would simply begin the adoption process 200 anew. In various embodiments, rejection 208 need not imply that a connection with client 120(b) is refused, but rather than changes in server loading 201 had occurred since message 202 was sent, thereby indicating that re-application by client 120(b) is appropriate. Assuming that rapid load changes do not continue and that loading on the selected server is not excessive, then client 102(b) may then establish a connection with the rejecting server 110 upon subsequent application to the server. In other embodiments, rejection message 208 may provide additional information to client 120(b) to aid the node in finding a suitable parent. Such a message 208 may include an internet protocol (IP) address of a backup server or a server with reduced loading, for example.

The particular processes and systems described above may be modified or enhanced in any manner. Randomness and/or delay times, for example, could be incorporated into the adoption protocol to aid in reducing “broadcast storms” following power outages or the like. Additionally, balancing may be carried out based upon any measure of server load, including any measure of processing capacity (e.g. CPU utilization), network capacity, an administratively assigned ‘load’ value, or any other appropriate factor as an equivalent to balancing based upon number of client connections.

To return to the example in originally presented in the Background section above, various techniques and systems described above could aid in balancing the loads between two servers with initial loads of “2” and “4”. If ten new nodes were to come online very quickly, the first node responding to the initial parent message would correctly establish a connection with the first server. As subsequent nodes applied to that server, however, the server would recognize that the current load (“3”) differed from the load assumed by the client (“2”), and would therefore reject the connection or take other remedial action. Upon subsequent application, the relative loading between the two servers would remain balanced due to the server verifying the client's knowledge of current server loading. Again, the particular techniques used in practical application may differ from those set forth above to create a multitude of alternate but equivalent embodiments.

It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A method of balancing loads between a client and a server having a server load, the method comprising the steps of:
transmitting a parent message comprising a first indication of the server load;
receiving an adoption message from the client, wherein the adoption message comprises the first indication of the server load;
comparing the first indication of the server load received in the adoption message to a current indication of the server load; and
accepting a connection from the client if the first indication corresponds to the current indication, and otherwise rejecting the connection.

2. The method of claim 1 wherein the server is a wireless switch and the client is a wireless access point.

3. The method of claim 1 wherein the server is a wireless access point and the client is a mobile user.

4. A digital storage medium having computer-executable instructions stored thereon, wherein the instructions are configured to execute the method of claim 1.

5. A wireless switch configured to execute the method of claim 1.

6. A wireless access point configured to execute the method of claim 1.

7. A method of establishing a connection from a client to a server having a server load, the method comprising the steps of:
receiving an indication of the server load from the server;
transmitting a request for the connection to the server, wherein the request comprises the indication of the server load; and
receiving a confirmation or a rejection of the connection from the server.

8. The method of claim 7 wherein the confirmation or rejection is determined based upon the indication of the server load contained in the request.

9. The method of claim 7 further comprising the step of establishing the connection with the server in response to confirmation.

10. The method of claim 7 further comprising the step of receiving a second indication of a second server load from a second server.

11. The method of claim 10 further comprising the step of comparing the indication of the server load to the second indication of the second server load.

12. The method of claim 11 wherein the transmitting step comprises transmitting the request to the server if the server load is less than the second server load, and transmitting the request to the second server if the second server load is less than the server load.

13. The method of claim 11 further comprising the step of requesting the indication of the server load.

14. A user module configured to execute the method of claim 7.

15. A wireless access point configured to execute the method of claim 7.

16. A user module configured to execute the method of claim 12.

17. A wireless access point configured to execute the method of claim 12.

18. A load-balanced wireless system operating over a digital network, the system comprising:
a first wireless switch coupled to the digital network and having a first switch load;
a second wireless switch coupled to the digital network and having a second switch load; and
a plurality of wireless access points coupled to the digital network, wherein each of the wireless access points are configured to receive indications of the first and second switch loads, to select a server switch from the first and second switches based upon the first and second switch loads, to transmit a request for a connection to the server switch that contains the indication of the switch load received from the server switch, and to establish a connection with the server switch in response to a confirmation message received from the server switch.

19. The wireless system of claim 18 wherein each of the plurality of wireless access points is configured to request the indications of the first and second switch loads from the first and second wireless switches, respectively.

20. The wireless system of claim 18 wherein the first and second wireless switches are each operable to receive the requests for connections from the wireless access points, to compare the indications of the switch load received in the requests to current indications of the server load, and to provide the confirmation messages if the server indications correspond to the current indications, and to otherwise reject the connections.
